(19) United States
(12) Patent Application Publication
(10) Pub. No.: US 2012/0179964 A1
(43) Pub. Date: Jul. 12, 2012

(54) METHOD AND APPARATUS FOR PROVIDING HELP OF PORTABLE TERMINAL

(75) Inventor: Jeong Seok YUN, Seoul (KR)

(73) Assignee: SAMSUNG ELECTRONICS CO., LTD., Gyeonggi-Do (KR)

(21) Appl. No.: 13/328,367

(22) Filed: Dec. 16, 2011

(30) Foreign Application Priority Data
Jan. 6, 2011 (KR) 10-2011-0001272

(51) Int. Cl. G06F 3/00

(52) U.S. Cl. 715/705

(57) ABSTRACT

A method and apparatus for providing a help function of a portable terminal are provided. The method for providing help of a portable terminal preferably includes: selecting a recommended help based on weights of respective help items set according to usage frequencies of respective functions included in the portable; displaying the selected recommended help; and reducing a weight of a help item corresponding to the selected recommended help by a preset size. The method and the apparatus apply a high weight to an added function, a changed function, and a function not used by a user, and outputs a selected recommended help (tip) based on the weight that allow the user to conveniently pick up and suitably use various functions of the portable terminal.

### CLAIM OF PRIORITY

Applicant claims priority from Korean Patent Application No. 10-2011-0001272, filed in the Korean Intellectual Property Office on Jan. 6, 2011, the contents of which are hereby incorporated by reference in its entirety.

### BACKGROUND OF THE INVENTION

1. Field of the Invention

The present invention relates to a method and apparatus for providing a help function of a portable terminal. More particularly, the present invention relates to a method of providing a help function for a portable terminal.

2. Description of the Related Art

In recent years, with the significant development of information and communication technology and a semiconductor technology, supply and use of all types of portable terminals have rapidly increased. In particular, recent portable terminals have developed have converged the traditional unique fields of mobile terminal and additional functionalities heretofore unknown in a single portable terminal. As a representative example of the portable terminals, a mobile communication terminal provides various functions such as a TV watching function (e.g., mobile broadcasting such as Digital Multimedia Broadcasting (DMB) or Digital Video Broadcasting (DVB)), a music playing function (e.g., MPEG Audio Layer-3 (MP3)), a photographing function (camera for both still and moving images), and an Internet access function as well as a general communication function such as speech call or message transmission/reception.

As illustrated above, as a portable terminal provides various functions, the using method thereof has become complicated. However, most users are not familiar with all of the functions of a portable terminal and as a result are often unaware of some functionality or inefficient at accessing some of the functions. Accordingly, a conventional method providing help to a portable terminal has been suggested. However, in a conventional method and apparatus for providing help with a portable terminal, a user must directly search a help menu with respect to a desired function using complicated menu trees, or must search a help menu through use of a search language after execution of a help menu.

### SUMMARY OF THE INVENTION

The present invention provides a method for providing help to operate a portable terminal that may set a weight according to usage frequencies and a presence of update of functions included in the portable terminal in order to provide a recommended help (tip) with respect to use of a particular function of the portable terminal to one side of a display unit based on the weight, and an apparatus thereof.

In accordance with an exemplary aspect of the present invention, a method for providing help to operate a portable terminal, preferably includes: selecting a recommended help based on weights of respective help items set according to usage frequencies of respective functions included in the portable terminal and associated with respective help item; displaying the selected recommended help on one side of a display unit; and reducing a weight of a help item corresponding to the selected recommended help item according to a preset size.

In accordance with another exemplary aspect of the present invention, an apparatus for providing help to operate a portable terminal, preferably includes: a memory storing a help database including at least one help item associated with a respective function of a plurality of respective functions of the portable terminal; a controller in communication with the memory and updating weights of respective help items in the help database according to usage frequencies of respective functions included in the portable terminal and presence of update of the respective functions, selecting a recommended help based on the weights of respective help items, and reducing a weight of a particular help item corresponding to the selected recommended help item by a preset size; and a display unit displaying the selected recommended help on the display unit.

As illustrated previously, a method and an apparatus for providing a help menu according to an exemplary embodiment of the present invention may provide help with respect to added or changed functions and/or functions not used by a user based on usage patterns of the portable terminal so as to provide help update information to one side of a display unit to improve using ability of the portable terminal by the user. The help item may be automatically selected and displayed under control of a controller.

### BRIEF DESCRIPTION OF THE DRAWINGS

The exemplary objects, features and advantages of the present invention will become more apparent from the following detailed description in conjunction with the accompanying drawings, in which:

FIG. 1 is a block diagram illustrating one possible configuration of a portable terminal according to an exemplary embodiment of the present invention;

FIG. 2 is a flowchart illustrating exemplary operation of a method for setting a weight of a help database to provide help in operation a portable terminal according to an exemplary embodiment of the present invention;

FIG. 3 is a flowchart illustrating a method for providing help to operate a portable terminal according to an exemplary embodiment of the present invention; and

FIG. 4 is a view illustrating an example of a help providing pattern according to an exemplary embodiment of the present invention.

### DETAILED DESCRIPTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

Prior to further description of the present invention, hereinafter, a mobile communication terminal is disclosed by way of example. However, the present invention is not limited thereto. In other words, the present invention is applicable to various devices including a touch screen allowing a user to recognize multi-touch. For example, the present invention is applicable to tablet PCs, Portable Multimedia Player (PMP), navigation terminals, smart phones, electronic book terminals, and electronic dictionary terminals, just to name some of the possible devices.

As used herein, the term “help mode” refers to a mode that selects one of help items included in a help database (DB) as a recommended help and outputs the selected help item preferably on one side of a display unit. The recommended help is selected based on a weight included in each help item. The weight may be set higher for an added or updated help item or to a help item with respect to a function which a user does not commonly use as determined by usage patterns.

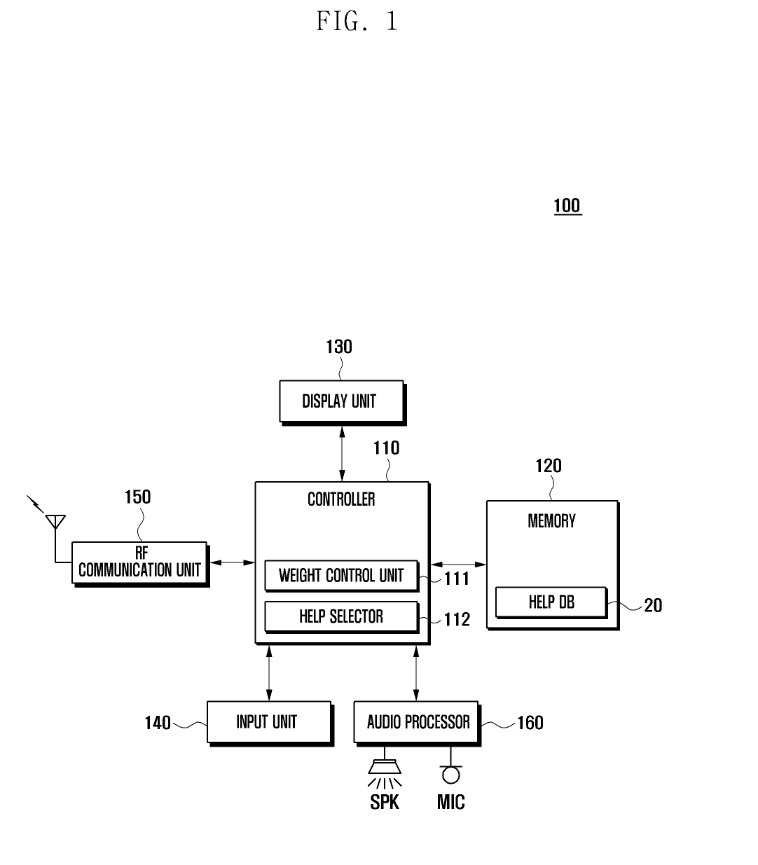

FIG. 1 is a block diagram illustrating a configuration of a portable terminal 100 according to an exemplary embodiment of the present invention.

Referring now to FIG. 1, a portable terminal 100 may preferably include a controller 110, a memory 120, a display unit 130, an input unit 140, a radio frequency (RF) communication unit 150, and an audio processor 160.

The controller 110, which is typically a processor or microprocessor, may preferably include a weight control unit 111 and a help selector 112, and the memory 120 may include a help database (DB) 20.

The audio processor 160 may be configured, for example, by a sound component transmitting/receiving an audio signal to perform encoding and decoding. The audio processor 160 may also include a codec and an audio amplifier AMP. The audio processor 160 connects with a microphone MIC and a speaker SPK. The audio processor 160 converts an analog voice signal input from the microphone MIC into a digital voice signal, converts the digital voice signal to data, and transmits the data to the controller 110. The audio processor 160 may also convert a digital voice signal input from the controller 110 into an analog voice signal, and outputs the sound through a speaker SPK. Further, the audio processor 160 may preferably output various audio signals (e.g., MP3 files, audio signals according to playback of moving image files) through the speaker SPK. In particular, the audio processor 160 according to the present invention may output a corresponding effect sound upon output of a recommended help through the speaker SPK. In addition, the audio processor 160 may output a sound effect indicating that there is update information of the help DB 20 through the speaker SPK.

The RF communication unit 150 preferably executes a communication function of the portable terminal 100. The RF communication unit 150 forms a communication channel with a wireless network (including, for example, a base station) to perform speech communication, image communication, and data communication. The RF communication unit 150 includes an RF transmitter (not shown) for up-converting a frequency of a signal for transmission and amplifying the signal, and an RF receiver (not shown) for low-noise-amplifying a received signal and down-converting a frequency of the signal. In particular, the RF communication unit 150 according to the present invention may receive a help DB 20 and/or updates thereto provided from a manufacturing company or a mobile communication enterprise of the portable terminal 100. The RF communication unit 150 may receive a message indicating that the help DB 20 has been updated. When a user requests an update of the help DB or of the functionality of the portable terminal 100, the RF communication unit 150 may receive the help information through an Over The Air (OTA) service. While the RF communication unit 150 receives a message indicating that the help DB 20 updated, the RF communication unit 150 may automatically receive the help DB 20. Meanwhile, the help DB 20 may be received through wired connection with a PC. A detailed description of the help DB 20 will be given in a description of the memory 120.

With continued reference to FIG. 1, the input unit 140 may include input keys and function keys that receive numerals or various character information, set various functions, and control functions of the portable terminal 100. For example, the input unit 140 may include a call key for requesting a speech call, an image call key for requesting an image call, a termination key for requesting termination of a speech call or an image call, a volume key and an arrow key capable of adjusting an output volume of an audio signal. In particular, the input unit 140 may transmit a signal selecting a recommended help to request output of detailed information, setting on/off of a help mode, and a signal requesting update of a help DB 20 to the controller 110. The input unit 140 may be configured by, for example one or a combination of input means including but not in any way limited to a touch pad, a touch screen, a button key pad, a joystick, and a wheel key.

The display unit 130 displays various types of menus of the portable terminal 100, as well as information input by a user, or information provided to the user. For example, the display unit 130 may provide various screens such as an idle screen, a message making screen, and a call screen according to utilization of the portable terminal 100. Upon activation of a help mode, the display unit 130 according to the present invention may display recommended help with respect to a function newly added and/or not previously used or not more than predetermined threshold because the user cannot recognize a particular function operating under the control of the controller 110.

At this time, the display unit 130 may display a recommended help in the form of a pop-up window or a widget. The display unit 130 may display the recommended help on an indicator region of the display unit 130 on which a residual amount of a battery, signal strength or presence of an alarm setting is displayed. When the displayed recommended help is selected (typically touched), the display unit 130 may output detailed information. Next, the display unit 130 may change and output the recommended help under the control of the controller 110. Moreover, the display unit 130 may change and display a recommended help every preset time period under the control of the controller 110. Each time a screen is switched from off to on, the display unit 130 may change and output the recommended help under the control of the controller 110. The display unit 130 may be configured by a Liquid Crystal Display (LCD), an Organic Light Emitted Diode (OLED), or an Active Matrix Organic Light Emitted Diode (AMOLED), or any other type of thin film technology display. In the meantime, when the display unit 130 is configured by a touch screen, the display unit 130 may also act as the input unit 140.

The memory 120, which is a non-transient machine readable data, may store user data as well as machine executable code necessary for operation of a function according to an exemplary embodiment of the present invention. For example, the memory 120 may store a program controlling an overall operation of the portable terminal 100, an operating system (OS) booting the portable terminal 100, and application programs necessary for other options functions, for example, a camera function, a sound playback function, an image or moving image playback function, a near distance RF communication function, and a multi-media contents playback function. Further, the memory 120 may store user data such as short messages, game files, music files, and movie files created according to use of the portable terminal 100. In particular, the memory 120 according to the present invention may store the help DB 20. The help DB 20 may map menu items included in an electronic manual of the portable terminal 100, inquiry contents that users frequently inquire about through a customer service center to a corresponding help and store the mapped results as one help item. The help DB 20 may include a ‘used’ field and a ‘priority’ field for each help item. The ‘used’ field is preferably a field indicating a used (usage) frequency of a function corresponding to each help item, and the ‘priority’ field is a field indicating a weight of each item. The weight may be set higher to a newly added help item and the weight may be set lower to a help item corresponding to a function frequently used by a user.

The controller 110 may control an overall operation of the portable terminal 100 and signal flow between internal blocks of the portable terminal 100. In particular, the controller 110 according to the present invention may update a weight of a help item according to a usage pattern of the portable terminal 100 by the user and update of the help DB 20. The controller 110 may output available functions (e.g., added functions, updated functions, non-used or frequently non-used functions) from among functions provided from the portable terminal 100 based on the weight at one side of the display unit 130 as a recommended help. To assist in operation, the controller 110 may include a weight control unit 111 and a help selector 112.

The weight control unit 111 may set a weight of each help item of a help DB 20 including menu items and inquiry contents of customers downloaded through at least one of a wired scheme or a wireless scheme, or included in a manual stored upon manufacturing the portable terminal 100. When the help DB 20 is updated through an Over The Air (OTA) service or a web page of a manufacturing company (or enterprise), the weight control unit 111 compares the updated help DB 20 with a previous help DB 20 to increase a weight of an added or corrected help item. When a specific function is executed by a user, the weight control unit 111 may reduce a weight of a help item corresponding to the executed function. To do this, each help item of the help DB 20 may contain a ‘used’ field indicating a usage frequency and a ‘priority’ field indicating a weight. When a help item is selected as a recommended help by the help selector 112 and displayed on the display unit 130, the weight control unit 111 may reduce a weight of the help item by a predetermined size with regard to future help recommendations. Thus, more heavily used functions will often have a lower weight regarding recommended help than less-used or never previously used functions. Further, when a user checks detailed information with respect to the displayed recommend help, the weight control unit 111 may reduce a weight of a corresponding help item by a predetermined size. Note any type of reduction size of the weight can be used in the embodiment.

With continued reference to FIG. 1, the help selector 112 may automatically select a recommended help to be provided to the user through the display unit 130 based on a weight of each help item of the help DB 20. The help selector 112 may select a candidate of a help using a weight-based random function. This help recommendation aims to provide the help with respect to a function having a high weight, an updated function or a function frequently non-used by a user to the user. Through this weighted determination, the user may naturally pick up or suitably use various functions of the portable terminal 100. In the meantime, the help selector 112 may change output of a recommended help item every time a certain period of time has elapsed or according to an on/off of the display unit 130. When a user checks detailed information of a recommended help output on the display unit 130, the help selector 112 may change the recommend help.

If the recommended help is selected, the controller 110 may output the recommended help selected by the help selector 112 on a side or other predetermined portion of the display unit 130 in the form of a widget or a pop-up window. The output may be displayed along a portion of an edge, at a bottom, top, etc., as desired. The controller 110 may also output the recommended help on an indicator region on which other informational items are displayed, such as a residual amount of a battery power (typically but not required to displayed as a percentage of a fully charged battery), Received Signal strength indication (RSSI), and presence of alarm setting are displayed. Next, if a selection (touch) signal of the recommended help is input, the controller 110 may output detailed information.

The portable terminal 100 according to an exemplary aspect of the present invention may selectively include structural elements for providing additional functions such as a camera module for taking images or moving images, a broadcasting receiving module for receiving broadcasting, a digital sound source playback module such as an MP3 module, a near distance wireless communication module, and a proximity sensor module for proximity sensing, just to name a few possibilities. Since the structural elements can be variously changed according to a convergence trend of digital devices, no elements are listed. However, the portable terminal 100 may include structural elements equivalent to the foregoing structural elements.

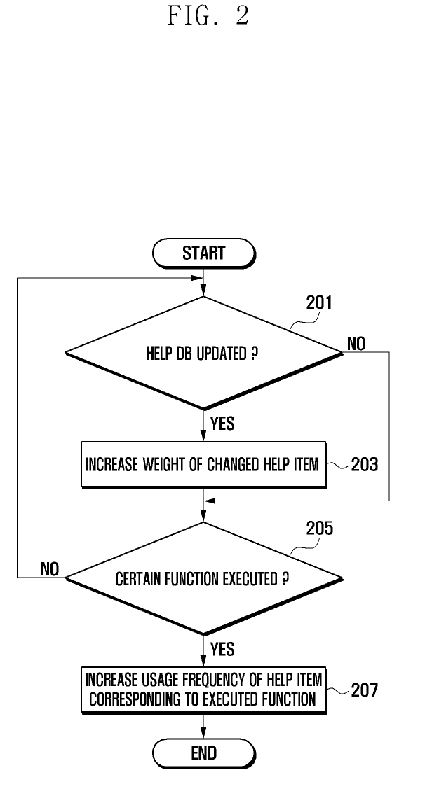

FIG. 2 is a flowchart illustrating exemplary operation of a method for setting a weight of a help database according to an exemplary embodiment of the present invention.

Prior to the description of the flowchart of FIG. 2, hereinafter, it is assumed that the portable terminal 100 downloads the help DB 20 in at least one of a wired scheme or a wireless scheme or stores the help DB 20 in the manufacturing time.

Referring now to FIG. 1 and FIG. 2, at (201) the controller 110 may check whether a help DB 20 is updated. The update of the help DB 20 may be provided through an OTA service or cable connection with a PC.

When at (201) the help DB 20 is not updated, the method may proceed to step 205.

Conversely, when the help DB 20 is updated at (201), then at (203) a weight control unit 111 of the controller 110 may download the updated help DB 20, compares it with a previous help DB 20, and increase a weight of a changed, namely, added or updated help item. In detail, the weight control unit 111 may increase a ‘priority field’ value of the changed help item.

Subsequently, at (205) the controller 110 determines whether or not a certain function, that is, one of functions provided from the portable terminal 100 is executed. When at 205, the certain function is not executed, the process returns to step 201, where the controller 110 determined whether or not the help DB has been updated.

Conversely, at (205) when the certain function is executed, then at (207) the controller 110 may execute a corresponding function and increase a used frequency of a help item corresponding to the executed function. In more detail, the weight control unit 111 may increase a ‘used field’ value of a help item corresponding to the executed function.

As previously illustrated hereinabove, the present invention may continuously update respective weights of help items included in the help DB 20 corresponding to a usage pattern of the portable terminal 100 and update the help DB 20. Through this process, the present invention provides information with respect to unused functions (or functions rarely used) and added or updated functions on one side of the display unit 130 as a recommended help item such that the user may select and suitably use various functions of the portable terminal 100.

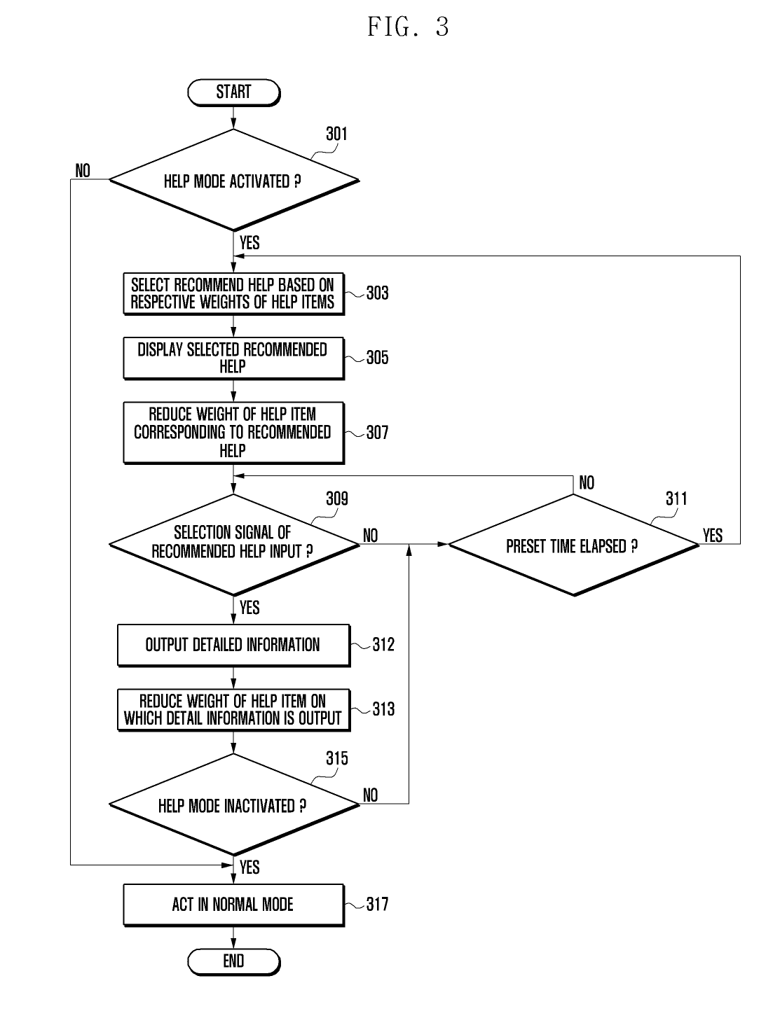

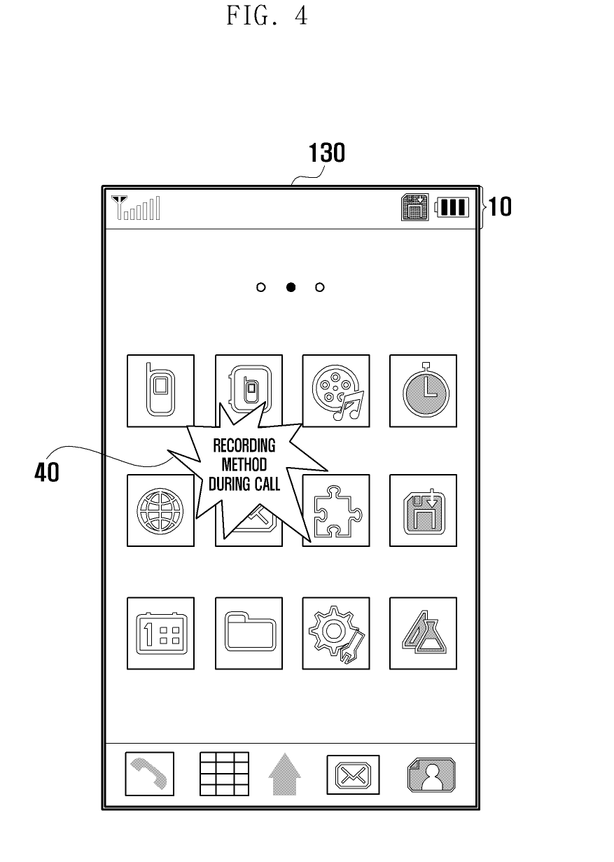

FIG. 3 is a flowchart illustrating exemplary operation of a method for providing a help of a portable terminal according to an exemplary embodiment of the present invention. FIG. 4 is a view illustrating an example of a help providing pattern according to an exemplary embodiment of the present invention.

Referring now to FIG. 1 to FIG. 4, at (301) controller 110 determines whether or not a help mode is activated. When at (301) the help mode is inactivated, then at (317) the controller 110 may act in a normal mode. Conversely, at (301) when the help mode is activated, then at (303) the controller 110 may select a recommend help to be provided to a user through a display unit 130 based on respective weights of help items in the help DB 20. To do this, the controller 110 may include a help selector 112 selecting the recommended help using a weight-based random function. At this time, the respective weights of help items may be set by the weight control unit 111 according to a used frequency and presence of update as illustrated in FIG. 2.

At (305), the control unit 110 may display the selected recommended help on one side or portion of a display unit 130. For example, as shown in FIG. 4, the controller 110 may output the recommended help on the display unit 130 in the form of a pop-up window 40. In this case, although not shown in FIG. 4, the controller 110 may control the display unit 130 to output the recommended help in the form of a widget or on an indicator region 10.

At (307), the controller 110 may reduce a weight of a help item corresponding to the displayed recommended help by a preset size. Then at (309) controller 110 may determine whether a selection (touch) signal of the recommended help output on the display unit 130 is input

When at (309) the selection signal of the recommended help is not input, then at (311) the controller 110 may determine whether a preset time elapses. When the preset time does not elapse, the method returns to step 309. Conversely, when the preset time elapses, the method returns to step 303. In other words, the controller 110 may select and display a newly recommended help on an area of the display unit 130 when a preset time elapses after displaying the recommended help.

With continued reference to FIG. 3, when at (309) a selection signal of the recommended help is input, then at (312) the controller 110 outputs detailed information with respect to the recommended help.

At (313) the controller 110 can reduce a weight of a help item on which the detail information is output, namely, corresponding to the recommended help by a preset size.

At (315), the controller 110 may determine whether the help mode is inactivated. When the help mode is not inactivated, the method proceed back to step 311. Conversely, when the help mode is inactivated, at (317) the controller 110 may act in a normal mode.

Meanwhile, the foregoing exemplary embodiments have illustrated that the controller 110 changes a recommended help display every predetermined time period. However, the present invention is not limited thereto. For example, the controller 110 may change the recommended help display according to on/off of the display unit 130. Further, when a user checks the displayed detailed information of a recommended help, the controller 110 may change the recommended help. In addition, the sizes of the weights reduced at step 307 and step 313 may be set to be identical with or different from each other.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

The foregoing method for changing a screen size using a multi-touch of the present invention may be implemented in an executable program command form by various computer means and be recorded in a computer readable recording medium that is non-transitory. In this case, the computer readable recording medium may include a program command, a data file, and a data structure individually or a combination thereof. In the meantime, the program command recorded in a recording medium may be specially designed or configured for the present invention or be known to a person having ordinary skill in a computer software field to be used.

The computer readable recording medium includes Magnetic Media such as hard disk, floppy disk, or magnetic tape, Optical Media such as Compact Disc Read Only Memory (CD-ROM) or Digital Versatile Disc (DVD), Magneto-Optical Media such as floptical disk, and a hardware device such as ROM. RAM, flash memory storing and executing program commands. Further, the program command includes a machine language code created by a complier and a high-level language code executable by a computer using an interpreter. The foregoing hardware device may be configured to be operated as at least one software module to perform an operation of the present invention.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method for providing a help information associated with at least one function of a portable terminal, the method comprising:
selecting a recommended help item based on weights of respective help items set according to usage frequencies of respective functions included in the portable terminal and associated with respective help items;
displaying the selected recommended help item; and
reducing a weight of a help item corresponding to the selected recommended help item according to a preset size.

2. The method of claim 1, wherein the selecting a recommended help item includes selecting based on a presence of an update of the respective help items.

3. The method of claim 1, further comprising receiving help information by an RF communication unit via Over the Air (OTA) service.

4. The method of claim 3, wherein the RF communication unit receives updated help information via the OTA service and stores the updates in the memory.

5. The method of claim 1, further comprising outputting detailed information of the selected recommended help item when the recommended help item is selected.

6. The method of claim 5, further comprising further reducing the weight of the corresponding help item by the preset size when the detailed information is output.

7. The method of claim 5, further comprising changing the displayed recommended help item to another help item after the output of the detailed information and outputting said another help item.

8. The method of claim 1, further comprising changing the recommended help item according to a change in an on/off status of the display unit.

9. The method of claim 1, further comprising changing the recommended help item for every preset time period.

10. The method of claim 1, further comprising changing the recommended help item periodically.

11. The method of claim 1, further comprising:
increasing a weight of an added help item or changed help item; and
increasing a usage frequency of a particular help item corresponding to a particular executed function when the particular function included in the portable terminal is executed.

12. The method of claim 1, further comprising:
determining whether a help mode is activated; and
selecting and displaying the recommended help item on one area of the display unit when the help mode is activated, and operating the portable terminal in a normal mode when the help mode is inactivated.

13. An apparatus for providing help of a portable terminal, the apparatus comprising:
a memory that stores a help database including at least one help item associated with a respective function of a plurality of respective functions of the portable terminal;
a controller in communication with the memory and updating weights of respective help items in the help database according to usage frequencies of respective functions included in the portable terminal, selecting a recommended help based on a weighted value of respective help items, and reducing a weight of a particular help item corresponding to the selected recommended help item by a preset size; and
a display unit that displays the selected recommended help item on the display unit.

14. The apparatus of claim 13, wherein the controller updates the weights of respective help items in the help database according to a presence of an update of the respective functions.

15. The apparatus of claim 14, further comprising an RF communication unit receiving help information via an Over the Air (OTA) service, and receiving updated help information via the OTA service.

16. The apparatus of claim 13, wherein the controller controls the display unit to output detailed information of the selected recommend help item after the recommended help item is selected.

17. The apparatus of claim 14, wherein the controller further reduces a weight of a corresponding help item by the preset size when or after the detailed information is output.

18. The apparatus of claim 14, wherein the controller changes the displayed recommended help item to another help item after the output of the detailed information and outputs the another help item.

19. The apparatus of claim 13, wherein the controller changes the recommended help item according to a change in on/off status of the display unit or changes the recommended help every preset time period.

20. The apparatus of claim 13, wherein the controller increases a weight of an added or changed help item and increases a usage frequency of a help item corresponding to an executed function when a function included in the portable terminal is executed.
